(19) United States
(12) Patent Application Publication
(10) Pub. No.: US 2012/0109775 A1
(43) Pub. Date: May 3, 2012

(54) SYSTEM, METHOD, AND COMPUTER PROGRAM PRODUCT FOR TECHNOLOGY ECOSYSTEM

(75) Inventors: William Berde, Nanuet, NY (US); Destin Lee Dexter, Peoria, AZ (US)

(73) Assignee: American Express Travel Related Services Company, Inc., New York, NY (US)

(21) Appl. No.: 12/917,165

(22) Filed: Nov. 1, 2010

(51) Int. Cl. G06Q 30/00

(52) U.S. Cl. 705/26.5

(57) ABSTRACT

A system for formation of product offerings is described. The system defines feature data related to attributes, benefits, or features. This feature data may be grouped into a package. These packages may be associated with base products such as a new or existing base transaction account. Also, these packages, alone or in combination with additional packages, may be grouped into a market offering for offering to a consumer.

### BACKGROUND

1. Field

The present disclosure generally relates to establishing a market offering, such as a bundle of features in a package.

2. Background

Financial institutions often offer products or benefits associated with a base product such as a transaction account. As times change, new products or benefits are usually in vogue with consumers such that financial institutions offering associated products or benefits are forced to quickly adapt to the changing tastes and preferences. While it may be easy to conceive, rolling out a new product with associated benefits and features often includes the efforts of many internal systems and departments.

As new products are introduced, they may also be added to a staggering variety of existing products. Each new product may result in substantial duplication of information and administration because each program typically includes unique data records and management parameters. Managing this crowded field of similar but not identical product mix may be difficult. Also, the relationship with the customer may be strained due to the complex sea of products associated with consumers and the difficulty of being well versed in the consumer's particular product.

Accordingly, there exists a need for a product offering management system that substantially integrates various market offerings. Such a system is needed to reduce implementation times and to reduce administrative overhead for each system.

### SUMMARY

The present disclosure meets the various needs by providing a system, method and computer program product for formation of product offerings. In one embodiment, the computer based system for formation of product offerings defines feature data. The system then groups the feature data in a package and assembles a market offering comprising the package. The market offering is offered to a consumer.

The feature data may be indexable and feature metadata may be linked to the feature data. The feature data includes instructions for automatic fulfillment by at least one of the computer based system or a third party computer based system. The success of the market offering to the consumer may be tracked based on at least one of acceptance or approval. The system may also establish a terms and conditions linked to each of the feature data, wherein a customized composite terms and conditions may be created based on the grouped feature data of the market offering.

The system may also receive a notification of acceptance of the market offering from the consumer; approve issuance of the market offering to the consumer; and issue the market offering to the consumer. The approving issuance of the market offering to the consumer may be based on an approval of a configurable base product associated with the market offering.

A feature inventory manager may at least one of define, modify or remove benefits associated with the feature data. The feature inventory manager may allow the creation of rules associated with the feature data. The feature inventory manager may also contain information about all of the feature data.

A package assembler may group feature data into packages and/or recommend a price associated with the grouping. The package offer assembler may track performance of the market offerings, wherein the market offering may associated with, or restricted from, a configurable base product.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1 depicts an exemplary system component diagram;

FIG. 2 depicts a technical system diagram;

FIG. 3 depicts an exemplary system interaction diagram;

FIG. 4 depicts a flowchart of an exemplary transaction account issuing cycle; and

FIG. 5 is a block diagram illustrating a detailed view of exemplary major system components for an automated system for providing formation of product offerings.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In one exemplary embodiment, a system, method and/or computer program product for formation of product offerings is disclosed. Specifically, in one exemplary embodiment, the system defines feature data related to attributes, benefits, or features that may be offered to a customer. This feature data may be grouped into a package. These packages may be associated with base products such as a new or existing base transaction account. Also, these packages (alone or in combination with additional packages) may be grouped into a market offering for offering to a consumer.

Feature data may comprise procedures and data which may be combined to construct compound entities or programs. Abstraction of these compound entities may assist with management as feature data is grouped in a larger system. Feature data may be modular such that they can be divided naturally into coherent parts that can be separately developed and maintained.

Feature data may be associated with various benefits, advantages, operability, and/or features. These features may be any features desired by an entity such as a financial institution. For instance, feature data may be associated with cash back, reward points, concierge services, trip insurance, and/or the like.

In one embodiment, feature data is used to define, modify and remove benefits, advantages, operability, and/or features associated with a product offering. Feature data may be subject to rules. These rules may be created by creators having various permission to create rules. Additionally, appended to the feature data, such as through metadata, is information associated with the available feature (third party or internal). Feature data may be housed and maintained through the Feature Inventory Manager application 20. New feature data may be added to the system at any suitable time. Similarly, feature data may be modified at any suitable time.

Features may be grouped into packages (or packs). The pricing of the various packages may vary based on the features of the packages. The package infrastructure system 100 may be configured to suggest a price of the package based upon the pricing of similar packages with similar feature contents.

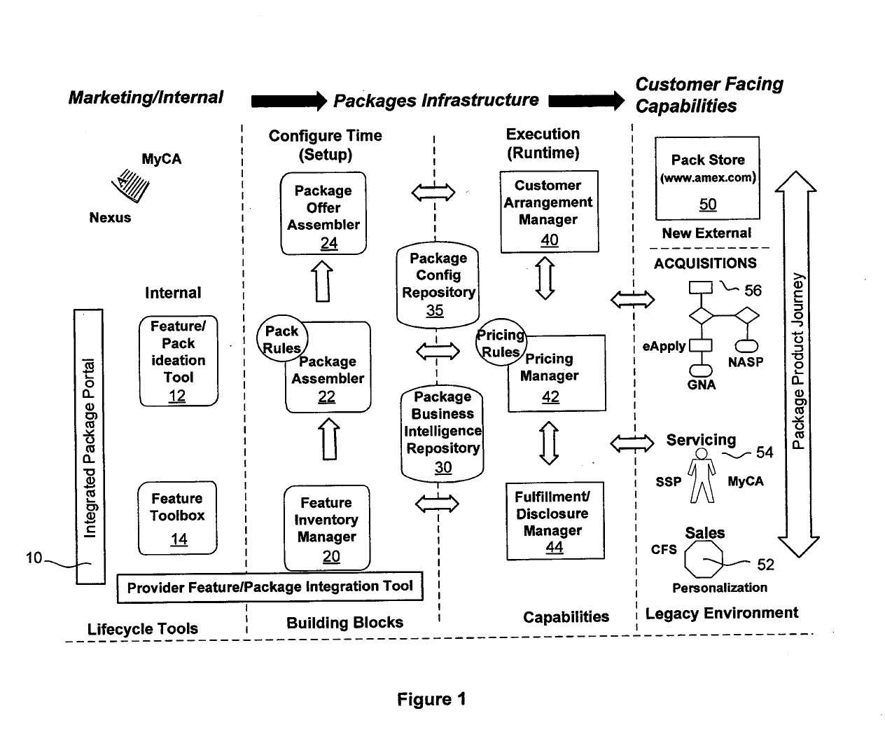

FIG. 1 illustrates an exemplary package infrastructure system 100 that includes marketing interface, infrastructure package engine system, infrastructure package lifecycle system and a consumer facing integration system. The marketing interface may comprise an integrated package portal 10 comprising a pack ideation tool portal component 12 and/or a feature toolbox portal component 14. The marketing interface may be coupled to the infrastructure package engine system and/or the infrastructure package lifecycle system.

The infrastructure package engine system may comprise a feature inventory manager portal component 20, a package assembler portal component 22, and a package offer assembler portal component 24. The package assembler 22 may house the pack rules service. The infrastructure package engine system may be coupled to the package configuration repository 35 and/or the package business intelligence repository 30.

The package configuration repository 35 (or package configuration engine) may relate package configuration information using a service oriented architecture approach (SOA). The package configuration repository 35 may house configuration information from the previously disclosed assembly components. For instance, the package configuration repository 35 may include a flexible set of design principles used during the phases of systems development and integration. This architecture may provide a loosely-coupled suite of services that can be used within multiple separate systems from several business domains. For example, several disparate departments within a company may develop and deploy SOA services in different implementation languages; their respective clients then may benefit from a well understood, well defined interface to access these services. The interface may be defined in terms of protocols and functionality. Stated another way, the package configuration repository 35 may separate functions into distinct units, or services, which developers make accessible over a network in order to allow users to combine and reuse in the production of applications. These services and their corresponding consumers communicate with each other by passing data in a well-defined, shared format, or by coordinating an activity between two or more services.

The package business intelligence repository 30 may provide analytical capabilities to generate reports relevant to the package architecture. For instance the package business intelligence repository 30 may report on package lifestyle activities and package performance or market offering adoption.

The package assembler portal component 22 may house and process the inventory of features, suggest potential groupings, the feature providers, methods of feature delivery, fees/costs associated with groupings and the respective features and customer communications. A feedback loop of successful product offerings and their respective packages may be useful to determine suitable features groupings or packages.

The package offer assembler portal component 24 may function to pair packages to market offers or offerings. The package offer assembler portal component 24 may track historical market offerings and trend performance related thereto. The package offer assembler portal component 24 may evaluate current market offerings and current market offering campaigns. The package offer assembler portal component 24 may further track resources dedicated to the current and historical market offerings and current market offering campaigns.

The infrastructure package lifecycle system may comprise a customer arrangement manager 40, a pricing manager application 42, and/or a fulfillment disclosure manager application 44. The pricing manager application 42 may house the pricing rules service. The infrastructure package engine system and/or the infrastructure package lifecycle system may be coupled to the consumer facing integration system.

The pricing manager application 42 may support the calculation of pricing associated with features, packages, and offers. Thus, dynamic, on-demand pricing may be enabled through the pricing manager system and its evaluation of package specific business rules. Additionally, dynamic, on-demand fees and refunds may be associated with the package's lifecycle. The pricing manager application 42 may enable a consumer to compare the costs and features of various packages. For example, through a split screen and/or same screen comparison.

The fulfillment/disclosure manager application 44 is responsible for providing collateral (i.e. welcome kit, confirmation email, disclosures, and/or the like) associated arbitration based on the package lifecycle activity. The fulfillment/disclosure manager application 44 also identifies the appropriate channel for collateral distribution based on a variety of factors such as past success, cost, and customer preferences.

The system 100 may include customer facing applications. These customer facing applications may interface with components that may link package configurations to individual consumer products. For instance, the customer arrangement manager 40 may include a customer's current and historical lifecycle activity with a market offering, package or transaction account service. Lifecycle activity may include enrollment, cancellation, renewal, suspension of market offering, or suspension of card service.

The consumer facing integration system 4 may comprise the pack “store” application 50, sales 52, servicing 54, and/or acquisitions 56.

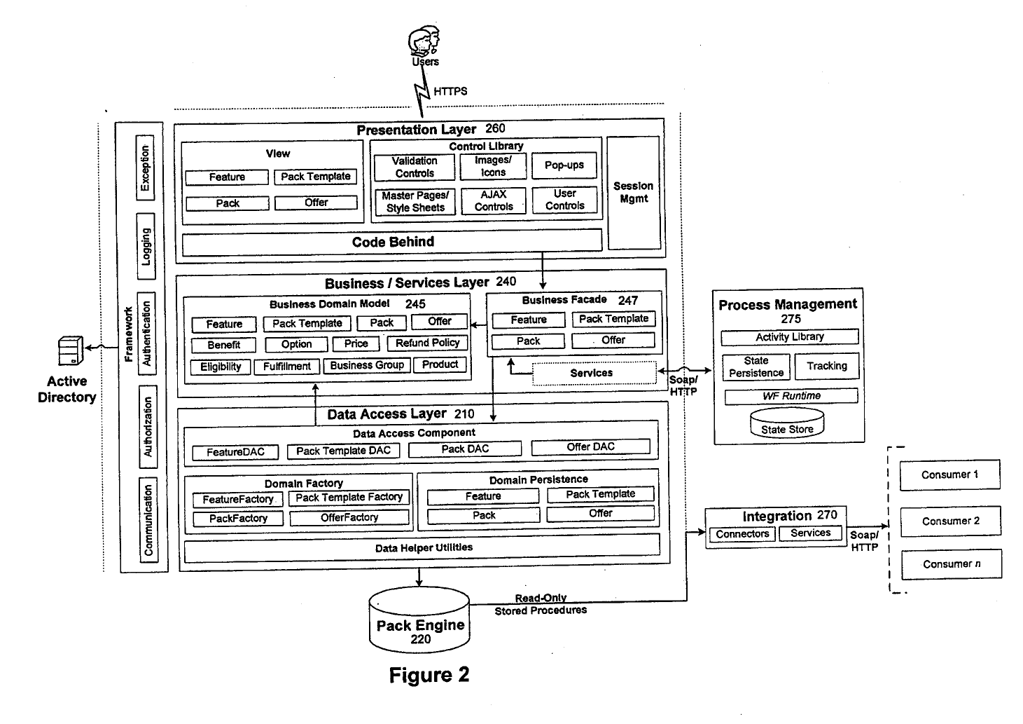

With reference to FIG. 2, an embodiment depicting the interaction between elements of system 100 is illustrated. For example, a data access layer 210 may communicate with a pack engine database 220, and the business/services layer 240. The business/services layer 240 may house the business domain model 245 and business façade 247. In turn, the business façade 247 may communicate with users via a presentation layer 260. The business/services layer 240 may also be coupled over a network to a process management system 275. The presentation layer 247 may be accessed remotely over a network such as a secure http connection. The pack engine 220 may be coupled to consumers via an integration application 270.

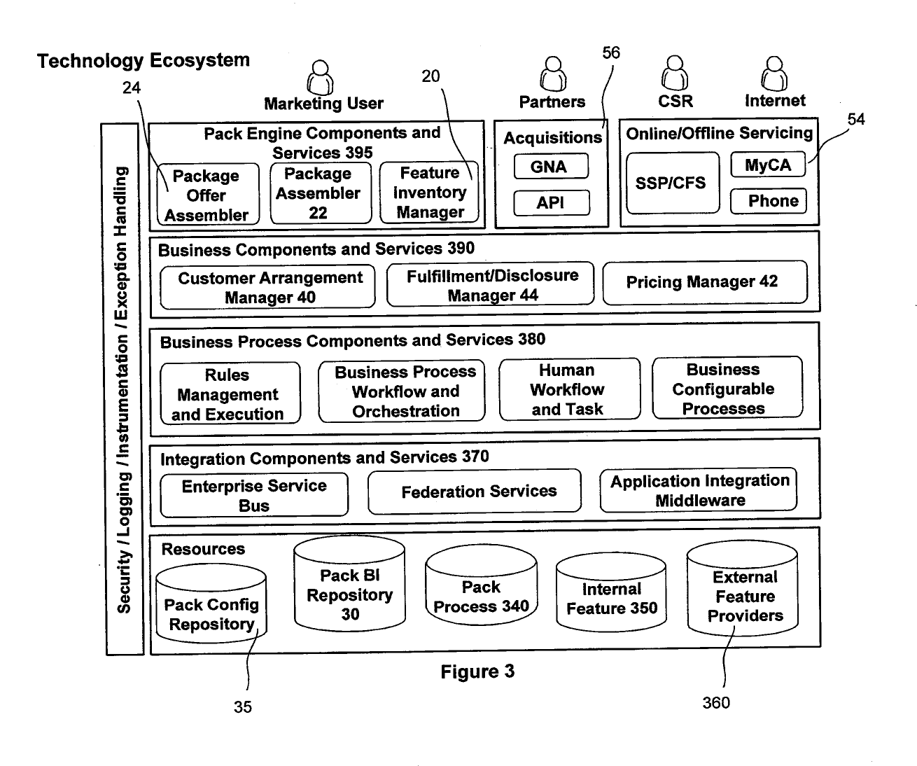

FIG. 3 depicts the high level interaction of various elements of an exemplary embodiment of the system 100. Each component may be coupled to the system 100 to harmoniously create the technology ecosystem. For instance, the resource databases, such as the package configuration repository 35, package business intelligence repository 30, package processor 340, internal feature provider database 350, and external feature provider database 360 may be called upon as needed by the components of the system 100. The pack engine components and services 395 may comprise the building blocks of the package infrastructure system 100. These building blocks may include the package offer assembler 24, the package assembler 22, and the feature inventory manager 20. Customer facing capabilities may include the acquisitions 56, servicing 54 and sales 52.

Integration components and services 370, business process components and services 380 and business components and services 390 may be coupled together to facilitate the system 100 functionality. For example, the business components and services hierarchy may comprise the customer arrangement manager 40, the pricing manager 42 and the fulfillment/disclosure manager 44. The business process components and services 380 may comprise applications and services directed to enterprise service business, federation services, and application integration middleware. The business components and services 390 may include the applications for rules management and execution, business process workflow and orchestration, human workflow and task step by step directions, and instructions for business configurable processes.

In one embodiment, features are defined with feature data and built prior to being bundled into a package. Feature data may include metadata. Feature data may be indexable. Feature data may include instructions for auto fulfillment or third party fulfillment.

Once features are defined, feature data may be grouped into a package or pack. This may be a business facing tool which will allow the business to assemble a feature into a pack and configure with a list price. Thus, a defined feature can allow a business to create a grouping without extensive backend technology services involvement.

The packages can be assembled into market offers (e.g., subsequent to packages being defined). The system 100 may determine a standard price associated with a package. A promotional or temporary price may be associated with a package. Market offers may be tracked based on performance, acceptability, satisfaction and adoption.

The pack lifestyle may include a market offer being presented to a consumer. For instance, a customer may check the details (i.e. features included in the package, benefits, etc.) alone or against other market offers. The consumer may review conditions of the market offer.

The consumer may enroll by accepting the market offering. The consumer may enroll by accepting the terms and conditions associated with the market offering. A customized terms and conditions may be dynamically created by the system based upon the associated packs. An associated welcome kit which may include a product such as a transaction instrument associated with a transaction account may be delivered to the consumer. The consumer may be charged a fee associated with accepting or using the market offering.

The consumer may identify additional desirable features associated with the accepted market offering. The customer may identify undesirable features associated with the accepted market offering. The market offering may be dynamically reconfigurable to match the desires of the consumer. As features are added and/or removed, terms and conditions and applicable fees/costs may be dynamically adjusted by the system 100. A third party may be contacted by the system 100 to initiate fulfillment if applicable (e.g., post enrollment). In some embodiments, post enrollment, a consumer may be enrolled into individual features as needed.

In one embodiment, a marketing team may determine a new benefit, such as access to a VIP lounge at an airport. Feature data associated with the feature may be created along with applicable definitions and instructions for fulfillment. This feature may be grouped with other features or it may be a stand alone feature comprising a pack. The system 100 may identify a fee/price to associate with the feature based on comparable feature fee/prices or the fee/price may be set by a programmer. Terms and conditions associated with the feature may be grouped into the pack's terms and conditions. The feature may be associated with a base product, such as a new or existing transaction account. In some cases, features may be priced at different levels based upon its associated base product. For instance, a first base product (e.g., a transaction account with a low annual fee) may comprise a different set of features than a second base product (e.g., a transaction account with a comparably higher annual fee). Some features may be configured to be restricted from being combined with a pre-selected base product and/or feature. For instance, the feature of “no annual fee” may be restricted from being associated with a feature of “unrestricted free international airfare” feature. The feature set of the base product may be reconfigurable at any time. For instance, if a transaction account holder or consumer wishes to change the features associated with their base product, such as their present transaction instrument, they will not be required to apply for and be issued a new transaction instrument comprising the new feature set. An acceptance, such as the acceptance of an updated terms and conditions, may result in new feature functionality being associated with the consumer's existing transaction instrument.

In some embodiments, a new customer may, by an interface of the system 100, enroll for and dynamically customize the features associated with the packages associated with a base product. In this embodiment, the fees/price of the package may be based upon the features selected and/or base produce selected. The system 100 may prepare a dynamic terms and conditions for acceptance and enrollment.

In various embodiments, an existing customer may, by an interface of the system 100, enroll for and dynamically customize and seamlessly harmonize the features and/or packages associated with their existing base product. In this embodiment, the fees/price of the base product may be adjusted based upon the features selected and/or base package selected. The system 100 may prepare a dynamic terms and conditions for acceptance.

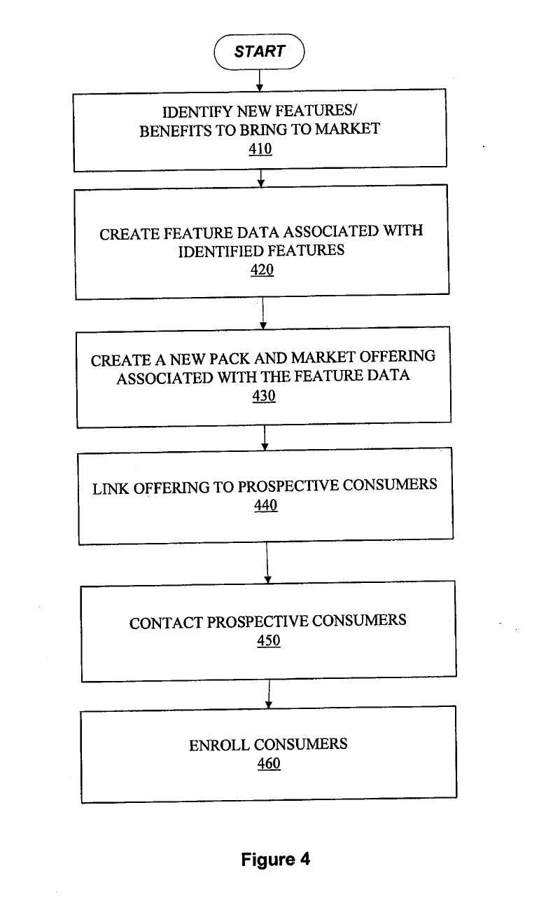

In one embodiment, with reference to FIG. 4, a product offering begins with business ideation identifying new features/benefits to bring to market 410. These new features are associated with respective feature data 420 and are entered into the inventory. Subsequent to the new features being entered into the inventory, the pack manager/pack engine creates a new pack and associated market offering 430. The market offering is offered to and/or linked to prospective consumers 440. The prospective consumers are contacted regarding market offerings 450 by the system 100. The consumer may send acknowledgment to the system of their intent to enroll and/or accept the market offering 460. For instance, enrolling and/or accepting the market offering may comprise being approved for a transaction account and enrolling in the transaction account. In some embodiments, approving issuance of the market offering to the consumer is based on the approval of a configurable base product associated with the market offering to the consumer.

The terms “member,” “card member,” “user,” “end user”, “consumer”, “customer,” “participant,” etc., and/or the plural form of these terms are used interchangeably throughout herein to refer to those persons or entities capable of accessing, using, being affected by and/or benefiting from the tool disclosed herein.

“Consumer”, or similar phrases as used herein, may include any individual, group, account holders, charity, entity, software and/or hardware that is associated with an account or profile in certain ways, such as a user, customer, member, rights holder, benefit from the account, affiliated with the account and/or the like. Transaction account holders may include all (or any subset of) account holders associated with a particular issuer, account holders with a certain type of account, primary account holders, subsidiary account holders, relatives of account holders, responsible parties of account holders, parties impacted by the account and/or the like. The transaction account may exist in a physical or non-physical embodiment. For example, a transaction account may be distributed in non-physical embodiments such as an account number, frequent-flyer account, and telephone calling account or the like. Furthermore, a physical embodiment of a transaction account may be distributed as a financial instrument.

Furthermore, the terms “business” or “merchant” (or similar phrases used herein) may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

A financial institution (or similar phrases used herein) may include any bank or entity typically operating under regulations of a card issuing association or other entity. The financial institution may also include any entity which issues transaction instruments to customers and/or cardmembers under a cardmember agreement for a cardmember account, such as a transaction account.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

An “account”, “account code”, or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

The account code may be distributed and stored in any form of plastic, electronic, magnetic, radio frequency, wireless, audio and/or optical device capable of transmitting or downloading data from itself to a second device. A customer account code may be, for example, a sixteen-digit transaction account code, although each transaction account provider has its own numbering system, such as the fifteen-digit numbering system used by American Express. Each company's transaction account codes comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account code may be, for example, any number or alpha-numeric characters that identify a particular merchant for purposes of card acceptance, account reconciliation, reporting, or the like.

It should be noted that the transfer of information in accordance with the present disclosure, may be completed in a format recognizable by a merchant system or account issuer. In that regard, by way of example, the information may be transmitted from an RFID device to an RFID reader or from the RFID reader to the merchant system in magnetic stripe or multi-track magnetic stripe format.

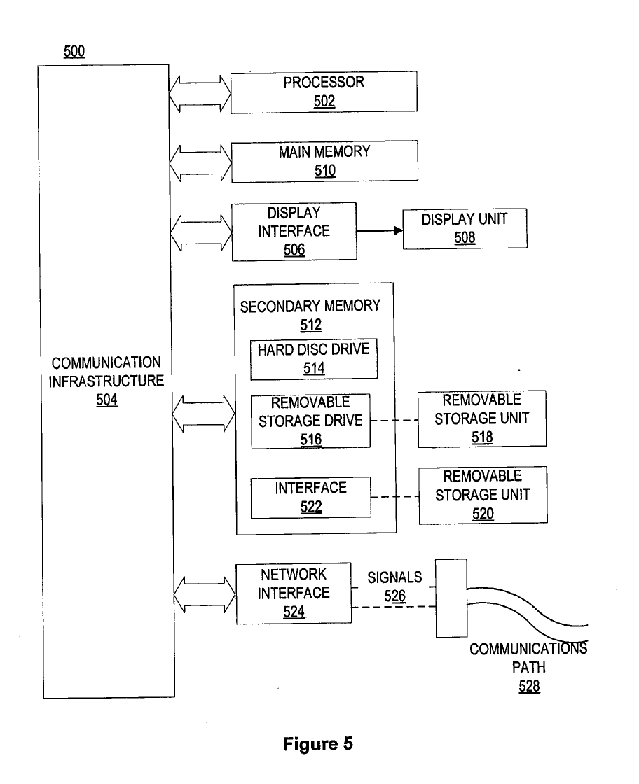

FIG. 5 is a block diagram of a sample computer system 500 that can be used in the implementation of one or more embodiments of the present disclosure. The present disclosure (i.e., systems and processes in FIGS. 1-4, or any part(s) or function(s) thereof) may be implemented using hardware, software or a combination thereof and may be implemented in one or more computer systems or other processing systems. However, the manipulations performed by the present invention were often referred to in terms, such as receiving or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices. In fact, in one embodiment, the invention is directed toward one or more computer systems capable of carrying out the functionality described herein.

The computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures. A system comprising a tangible, non-transitory memory communicating with a processor for formation of product offerings, the tangible, non-transitory memory having instructions stored thereon that, in response to execution by the processor, cause the processor to perform operations comprising: defining, by the processor, feature data; grouping, by the processor, the feature data in a package; assembling, by the processor, a market offering comprising a package; and offering, by the processor, the market offering to a consumer. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Any component of the technology ecosystem/and or package infrastructure system 100 may be represented via computer system 500 and/or elements of computer system 500. Computer system 500 can include a display interface 506 that forwards graphics, text, and other data from the communication infrastructure 504 (or from a frame buffer not shown) for display on the display unit 508.

Computer system 500 also includes a main memory 510, preferably random access memory (RAM), and may also include a secondary memory 512. The secondary memory 512 may include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a well known manner. Removable storage unit 518 represents a floppy disk, magnetic tape, optical disk, etc. which is read by and written to by removable storage drive 516. As will be appreciated, the removable storage unit 518 includes a computer usable storage medium having stored therein computer software and/or data.

In alternative embodiments, secondary memory 512 may include other similar devices for allowing computer programs or other instructions to be loaded into computer system 500. Such devices may include, for example, a removable storage unit 520 and an interface 522. Examples of such may include a program cartridge and cartridge interface (such as that found in video game devices), a removable memory chip (such as an erasable programmable read only memory (EPROM), or programmable read only memory (PROM)) and associated socket, and other removable storage units 520 and interfaces 522, which allow software and data to be transferred from the removable storage unit 520 to computer system 500.

Computer system 500 may also include a communications interface/path 528. Communications interface/path 528 allows software and data to be transferred between computer system 500 and external devices. Examples of communications interface/path 528 may include a modem, a network interface (such as an Ethernet card), a communications port, a Personal Computer Memory Card International Association (PCMCIA) slot and card, etc. Software and data transferred via communications interface/path 528 are in the form of signals 526 which may be electronic, electromagnetic, optical or other signals capable of being received by communications interface/path 528. These signals are provided to communications interface/path 528 via a communications path (e.g., channel). This channel carries signals and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 516, a hard disk installed in hard disk drive 514, and signals. These computer program products provide software to computer system 500. The invention is directed to such computer program products.

Computer programs (also referred to as computer control logic) are stored in main memory 510 and/or secondary memory 512. Computer programs may also be received via network interface 524. Such computer programs, when executed, enable the computer system 500 to perform the features of the present invention, as discussed herein. In particular, the computer programs, when executed, enable the processor 502 to perform the features of the present invention. Accordingly, such computer programs represent controllers of the computer system 500.

In an embodiment where the invention is implemented using software, the software may be stored in a computer program product and loaded into computer system 500 using removable storage drive 516, hard drive 514 or network interface 524. The control logic (software), when executed by the processor 502, causes the processor 502 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention is implemented using a combination of both hardware and software.

### CONCLUSION

While various embodiments of the present invention have been described herein, it should be understood that they have been presented by way of example, and not limitation. It will be apparent to persons skilled in the relevant art(s) that various changes in form and detail can be made therein without departing from the spirit and scope of the present invention). Thus, the present invention should not be limited by any of the herein described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

In various embodiments, the methods described herein are implemented using the various particular machines described herein. The methods described herein may be implemented using the particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a non-transitory computer readable medium and/or memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; credit bureau data; third party data; financial institution data; and/or like data useful in the operation of the system. As those skilled in the art will appreciate, user computer may include an operating system (e.g., Windows NT, 95/98/2000, XP, Vista, OS2, UNIX, Linux, Solaris, MacOS, etc.) as well as various conventional support software and drivers typically associated with computers. A user may include any individual, business, entity, government organization, software and/or hardware that interact with a system. A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, and/or the like. Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As used herein, the term “network” includes any electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a non-transitory computer-readable storage medium having computer-readable program code means embodied in the storage medium. Any suitable computer-readable storage medium may be utilized, including hard disks, CD-ROM, optical storage devices, magnetic storage devices, and/or the like.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.”

Moreover, where a phrase similar to “at least one of A, B, and C” or “at least one of A, B, or C” is used in the claims or the specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the invention has been described as a method, it is contemplated that it may be embodied as computer program instructions on a tangible computer-readable carrier, such as a magnetic or optical memory or a magnetic or optical disk. All structural, chemical, and functional equivalents to the elements of the herein-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
defining, by a computer based system for formation of product offerings, feature data;
grouping, by the computer based system, the feature data in a package;
assembling, by the computer based system, a market offering comprising the package; and
offering, by the computer based system, the market offering to a consumer.

2. The method of claim 1, wherein feature metadata is linked to the feature data.

3. The method of claim 1, wherein the feature data is indexable.

4. The method of claim 1, wherein the feature data includes instructions for automatic fulfillment by at least one of the computer based system or a third party computer based system.

5. The method of claim 1, wherein success of the market offering to the consumer is tracked based on at least one of acceptance or approval.

6. The method of claim 1, further comprising establishing a terms and conditions linked to each of the feature data, wherein a customized composite terms and conditions is created based on the grouped feature data of the market offering.

7. The method of claim 1, wherein a feature inventory manager at least one of defines, modifies or removes benefits associated with the feature data.

8. The method of claim 1, wherein a feature inventory manager allows the creation of rules associated with the feature data.

9. The method of claim 1, wherein a feature inventory manager contains information about all of the feature data.

10. The method of claim 1, wherein a package assembler at least one of groups feature data into packages or recommends a price associated with the grouping.

11. The method of claim 1, wherein a package offer assembler tracks performance of the market offerings.

12. The method of claim 1, wherein the market offering is associated with a configurable base product.

13. The method of claim 1, wherein the market offering is restricted from being associated with a configurable base product.

14. The method of claim 1, further comprising:
receiving, by the computer based system, a notification of acceptance of the market offering from the consumer;
approving, by the computer based system, issuance of the market offering to the consumer; and
issuing, by the computer based system, the market offering to the consumer.

15. The method of claim 14, wherein the approving issuance of the market offering to the consumer is based on an approval of a configurable base product associated with the market offering.

16. The method of claim 1, furthering comprising at least one of adding or removing the package of the market offering after at least one of receiving the notification of acceptance of the market offering from the consumer or approving issuance of the market offering to the consumer.

17. The method of claim 1, wherein the consumer builds a customized market offering based on a selection of packages.

18. The method of claim 1, wherein the offering of the market offering to the consumer comprises harmonizing features associated with an existing base product of an existing consumer with a customizable base product comprising the package with the feature data associated with features of the existing base product.

19. A system comprising:
a tangible, non-transitory memory communicating with a processor for formation of product offerings,
the tangible, non-transitory memory having instructions stored thereon that, in response to execution by the processor, cause the processor to perform operations comprising:
defining, by the processor, feature data;
grouping, by the processor, the feature data in a package;
assembling, by the processor, a market offering comprising the package; and
offering, by the processor, the market offering to a consumer.

20. An article of manufacture including a non-transitory, tangible computer readable medium for formation of product offerings having instructions stored thereon that, in response to execution by a computer-based system for formation of product offerings, cause the computer-based system to perform operations comprising:
defining, by the computer based system, feature data;
grouping, by the computer based system, the feature data in a package;
assembling, by the computer based system, a market offering comprising the package; and
offering, by the computer based system, the market offering to a consumer.
